(19) United States
(12) Patent Application Publication
(10) Pub. No.: US 2010/0328278 A1
(43) Pub. Date: Dec. 30, 2010

(54) Light Emitting Device, Electronic Device, and Method for Driving Pixel Circuit

(75) Inventors: Hideto Ishiguro, Shiojiri-shi (JP); Satoshi Yatabe, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/821,839

(22) Filed: Jun. 23, 2010

(30) Foreign Application Priority Data
Jun. 29, 2009 (JP) 2009-153670

(51) Int. Cl. G09G 5/00

(52) U.S. Cl. 345/205

(57) ABSTRACT

A light emitting device includes: a pixel circuit; and a driving circuit that drives the pixel circuit, wherein the pixel circuit includes: a light emitting element; a driving transistor that is connected to the light emitting element in series; a storage capacitor that is located between a gate of the driving transistor and a source of the driving transistor; and a selecting transistor that is located between the gate of the driving transistor and a signal line that corresponds to the pixel circuit, after a writing period starts, the driving circuit sets a potential of a selection signal to a selection potential to turn on the selecting transistor and outputs a data potential to the signal line to cause a current corresponding to the data potential to flow in the driving transistor, the selection signal being to be supplied to the gate of the selecting transistor, the data potential being changed over time, and after the driving circuit sets the potential of the selection signal to the selection potential and outputs the data potential, the driving circuit changes, from the selection potential, the potential of the selection signal over time until the end time of the writing period to turn off the selecting transistor and thereby stop supply of the data potential and sets, to a rate corresponding to a gradation specified for the pixel circuit, a rate of change of the data potential at the time when the supply of the data potential to the driving transistor is stopped.

### BACKGROUND

1. Technical Field

The present invention relates to a technique for driving a light emitting element such as an organic electroluminescence (EL) element.

2. Related Art

In a light emitting device in which driving transistors control driving currents that are supplied to light emitting elements, there is a problem that electric characteristics of the driving transistors vary (or are different from a target value or the elements vary). JP-A-2007-310311 discloses a technique that compensates for a variation in a threshold voltage of a driving transistor and a variation in mobility of the driving transistor (and a variation in the amount of a driving current) by setting a voltage that is applied across the gate and source of the driving transistor to the threshold voltage and changing the set voltage on the basis of gradation.

### SUMMARY

However, the variation in the amount of the driving current is effectively compensated for by the technique described in JP-A-2007-310311 only when a particular gradation is specified. The variation in the amount of the driving current cannot be compensated for depending on the gradation. An advantage of some aspects of the invention is that it provides a technique for suppressing a variation in the amount of a driving current for each of multiple gradations.

According to a first aspect of the invention, a light emitting device includes: a pixel circuit; and a driving circuit that drives the pixel circuit, wherein the pixel circuit includes: a light emitting element; a driving transistor that is connected to the light emitting element in series; a storage capacitor that is located between a gate of the driving transistor and a source of the driving transistor; and a selecting transistor that is located between the gate of the driving transistor and a signal line that corresponds to the pixel circuit, after a writing period starts, the driving circuit sets a potential of a selection signal (e.g., scanning signal shown in FIG. 6) to a selection potential to turn on the selecting transistor and outputs a data potential to the signal line to cause a current corresponding to the data potential to flow in the driving transistor, the selection signal being to be supplied to the gate of the selecting transistor, the data potential being changed over time, and after the driving circuit sets the potential of the selection signal to the selection potential and outputs the data potential, the driving circuit changes, from the selection potential, the potential of the selection signal over time until the end time of the writing period to turn off the selecting transistor and thereby stop supply of the data potential and sets, to a rate corresponding to a gradation specified for the pixel circuit, a rate of change of the data potential over time at the time when the supply of the data potential to the driving transistor is stopped.

According to the first aspect of the invention, the data potential that is changed over time is supplied to the gate of the driving transistor. Thus, the current (that does not depend on a threshold voltage of the driving transistor and mobility of the driving transistor) that corresponds to the rate of change of the data potential over time flows in the driving transistor. It is preferable that a voltage that is applied across both ends of the storage capacitor be set to a value that is necessary for a current (that corresponds to the rate of change of the potential of the driving signal over time at the time when the supply of the driving signal to the driving transistor is stopped) to flow in the driving transistor. Specifically, it is preferable that the voltage that is applied across both ends of the storage capacitor be set to a value so that the current flows in the driving transistor, the amount of the current corresponding to a value obtained by multiplying a capacitance of a capacitor by the rate of change of the data potential over time at the time when the supply of the data potential to the driving transistor is stopped, the capacitor being provided for the light emitting element. The rate of change of the data potential over time at the time when the supply of the data potential to the driving transistor is stopped is variably set on the basis of the gradation specified for the pixel circuit. The amount of the driving current that is to be supplied to the light emitting element on the basis of the voltage applied across both ends of the storage capacitor is set to a value (that does not depend on the threshold voltage of the driving transistor and the mobility of the driving transistor) that corresponds to the specified gradation. The rate of change of the potential over time indicates the same meaning as a gradient of the potential with respect to a time axis and a value obtained by differentiating the potential with respect to time.

According to the first aspect of the invention, after the potential of the selection signal is set to the selection potential, the potential of the selection signal is changed over time from the selection potential until the end time of the writing period so that the selecting transistor is turned off. Thus, the amount of change in the potential of the selection signal when the selecting transistor is turned off can be sufficiently smaller than the amount of change in the potential of the selection signal when the potential is abruptly changed from the selection potential to a non-active level to turn off the selecting transistor. Therefore, it is possible to suppress the amount of a change (that is caused by a feed-through effect that occurs when the selecting transistor is switched to the OFF state) in the potential of the gate of the driving transistor. It is, therefore, possible to suppress deviation of the brightness of a pixel from a desired target value.

It is preferable that the potential of the selection signal be changed over time at a constant rate after the potential of the selection signal is set to the selection potential and until the end time of the writing period. In this case, the amount of the change in the potential of the selection signal when the selecting transistor is turned off is the same regardless of the specified gradation. It is, therefore, possible to suppress a variation in the amount (that varies depending on the specified gradation) of the change (that is caused by the feed-through effect that occurs when the selecting transistor is switched to the OFF state) in the potential of the gate of the driving transistor.

It is preferable that the potential of the selection signal be set so that the selecting transistor is turned off during the writing period after the rate of change of the potential of the gate of the driving transistor over time becomes equal to the rate of change of the potential of the source of the driving transistor over time. In this case, the driving transistor can reliably reach an equilibrium state (in which the rate of change of the potential of the source of the driving transistor over time is equal to the rate of change of the data potential over time) during the writing period.

It is preferable that the pixel circuit further include a first switching element that is located between the source of the driving transistor and a reset line, a second switching element that is located between an initialization line and a node that is located between the gate of the driving transistor and the selecting transistor, and a light emission control transistor that is connected to the light emitting element and the driving transistor in series; the driving circuit turn off the light emission control transistor and the selecting transistor and turn on the first switching element and the second switching element for an initialization period that ends before the writing period so that a voltage that is applied across the gate and source of the driving transistor is initialized; the driving circuit perform a compensating operation to turn off the first switching element and to turn on the light emission control transistor for a compensation period that starts after the initialization period and ends before the writing period so that the voltage that is applied across the gate and source of the driving transistor becomes asymptotic to a threshold voltage; and the driving circuit turn off the second switching element for the writing period and keep the light emission control transistor turned on for a light emission period to change the potential (potential of a point at which the driving transistor and the light emitting element are connected to each other) of the source of the driving transistor so that the light emitting element emits light, the light emission period starting after the writing period. For example, when the driving transistor is an N-channel transistor, the driving circuit causes the light emitting element to emit light for a light emission period by increasing the potential of the source of the driving transistor. On the other hand, when the driving transistor is a P-channel transistor, the driving circuit causes the light emitting element to emit light for the light emission period by reducing the potential of the source of the driving transistor.

It is also preferable that the potential of the source of the driving transistor be set so that the light emitting element is in a non-emission state for the initialization period, the compensation period and the writing period. If the light emitting element emitted light during a period (e.g., the initialization period, the compensation period or the like) before the light emission period, the contrast of a displayed image would be reduced. The light emitting element, however, is in an OFF state (non-emission state) before the light emission period. It is, therefore, possible to suppress a reduction in the contrast of the displayed image.

The light emitting device according to the first aspect of the invention may be used in various electronic devices. A typical one of the electronic devices is a device that uses the light emitting device as a display device. A personal computer and a mobile phone may be used as an electronic device according to a second aspect of the invention. The light emitting device according to the first aspect of the invention may be used for purposes other than displaying of an image. For example, the light emitting device according to the first aspect of the invention may be used as an exposure device (light head) that irradiates an image carrier (such as a photosensitive drum) with light to form a latent image on the image carrier.

According to a third aspect of the invention, a method for driving a pixel circuit that includes a light emitting element; a driving transistor that is connected to the light emitting element in series; a storage capacitor that is located between a gate of the driving transistor and a source of the driving transistor; and a selecting transistor that is located between the gate of the driving transistor and a signal line that corresponds to the pixel circuit, includes: after a writing period starts, setting a potential of a selection signal to a selection potential to turn on the selecting transistor and outputting a data potential to the signal line to cause a current corresponding to the data potential to flow in the driving transistor, the selection signal being to be supplied to the gate of the driving transistor, the data potential being changed over time at a rate that corresponds to a gradation specified for the pixel circuit; and after the setting of the potential of the selection signal to the selection potential and the outputting of the data potential, changing the potential of the selection signal over time from the selection potential until the end time of the writing period to turn off the selecting transistor and thereby stop supply of the data potential to the driving transistor. An effect that is the same as or similar to an effect achieved by the light emitting device according to the first aspect of the invention can be achieved in the driving method.

### BRIEF DESCRIPTION OF THE DRAWINGS

The invention will be described with reference to the accompanying drawings, wherein like numbers reference like elements.

FIG. 1 is a circuit diagram showing driving principles of a pixel circuit.

FIG. 2 is a graph showing the driving principles of the pixel circuit.

FIGS. 3A and 3B are graphs showing a time period that is necessary for a driving transistor to reach an equilibrium state when the rate of change of a data potential over time is high.

FIGS. 4A and 4B are graphs showing a time period that is necessary for the driving transistor to reach the equilibrium state when the rate of change of the data potential over time is low.

FIG. 5 is a block diagram showing a light emitting device according to an embodiment of the invention.

FIG. 6 is a timing chart of operations of the light emitting device.

FIG. 7 is a circuit diagram of the pixel circuit.

FIG. 8 is a diagram showing operations of the pixel circuit that is operated for an initialization period.

FIG. 9 is a diagram showing operations of the pixel circuit that is operated for a compensation period.

FIG. 10 is a diagram showing operations of the pixel circuit that is operated for a writing period.

FIG. 11 is a diagram showing the relationship between the data potential and the potential of a scanning signal.

FIG. 12 is a diagram showing operations of the pixel circuit that is operated during a light emission period.

FIG. 13 is a diagram showing the relationship between a data potential and the potential of a scanning signal in a comparative example.

FIG. 14 is a diagram showing the relationship between the data potential and the potential of the scanning signal according to the embodiment of the invention.

FIG. 15 is a diagram showing an effect of the invention.

FIG. 16 is a diagram showing the waveforms of scanning signals in the comparative example.

FIG. 17 is a diagram showing an effect of the invention.

FIG. 18 is a simplified plan view of the light emitting device according to the embodiment of the invention.

FIG. 19 is a block diagram showing the outline configuration of a scanning line driving circuit.

FIG. 20 is a diagram showing the waveform of a scanning signal that is generated by an output buffer section.

FIG. 21 is a diagram showing the waveform of a scanning signal in a modified example of the invention.

FIG. 22 is a diagram showing the waveform of a scanning signal in another modified example of the invention.

FIG. 23 is a diagram showing the waveform of a scanning signal in another modified example of the invention.

FIG. 24 is a diagram showing the relationship between a data potential and the potential of a scanning signal in another modified example of the invention.

FIG. 25 is a perspective view of a specific configuration of an electronic device according to the invention.

FIG. 26 is a perspective view of another specific configuration of the electronic device according to the invention.

FIG. 27 is a perspective view of another specific configuration of the electronic device according to the invention.

### DESCRIPTION OF EXEMPLARY EMBODIMENTS

### A: Driving Principles

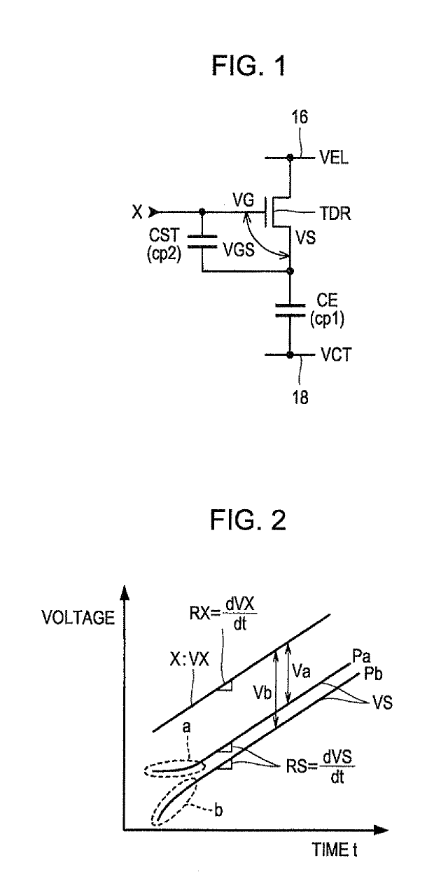

Before describing an embodiment of the invention, principles that are used to drive a pixel circuit will be described. FIG. 1 shows a circuit that includes an N-channel driving transistor TDR and a capacitor CE (having a capacitance cp1) that are connected to each other in series on a line that connects a feeding line 16 to a feeding line 18.

A potential VEL is supplied to the feeding line 16, while a potential VCT (VCT<VEL) is supplied to the feeding line 18. A drain of the driving transistor TDR is connected to the feeding line 16. The capacitor CE is located between a source of the driving transistor TDR and the feeding line 18. A storage capacitor CST (having a capacitance cp2) is located between a gate of the driving transistor TDR and the source of the driving transistor TDR. Thus, a voltage VGS that is a difference between a potential VG of the gate of the driving transistor TDR and a potential VS of the source of the driving transistor TDR (VGS=VG−VS) is applied across both ends of the storage capacitor CST.

A driving signal X is supplied to the gate of the driving transistor TDR. A potential VX of the driving signal X is changed over time as shown in FIG. 2. FIG. 2 shows an example in which the potential VX is linearly increased over time at a predetermined rate RX (=dVX/dt). FIG. 2 also shows a change in the potential VS of the source over time in the case where the driving transistor TDR has electric characteristics Pa (e.g., the mobility and the threshold voltage). FIG. 2 also shows a change in the potential VS of the source over time in the case where the driving transistor TDR has electric characteristics Pb (e.g., the mobility and the threshold voltage).

The potential VG (potential VX) of the gate of the driving transistor TDR is increased by the supply of the driving signal X. When the voltage VGS applied across the gate and source of the driving transistor TDR exceeds a threshold voltage VTH of the driving transistor TDR, a current IDS flows between the drain and source of the driving transistor TDR. The amount of the current IDS is expressed by the following equation (1). In equation (1), μ denotes the mobility of the driving transistor TDR; W/L denotes a ratio of the width W of a channel of the driving transistor TDR to the length L of the channel of the driving transistor TDR; and Cox denotes a capacitance per unit area of a gate insulating film that is included in the driving transistor TDR.

IDS=½·μ·W/L·Cox·(VGS−VTH)² (1)

When the current IDS flows in the driving transistor TDR, charges are accumulated in the capacitor CE and the storage capacitor CST. Thus, the potential VS of the source of the driving transistor TDR changes over time at a rate RS (=dVS/dt), as shown in FIG. 2. The relationship between the current IDS and the potential VS of the source of the driving transistor TDR is expressed by the following equation (2).

IDS=dQ/dt=cp2·(dVS/dt−dVX/dt)+cp1·dVS/dt (2)

As shown by a portion a of FIG. 2, when the rate RS (i.e., a gradient of the potential VS with respect to time t) of change of the potential VS of the source of the driving transistor TDR over time is lower than the rate RX of change of the potential VX of the driving signal X over time, the voltage VGS that is applied across the gate and source of the driving transistor TDR is increased over time. When the voltage VGS is increased, the amount of the current IDS is also increased as shown in equation (1). As is apparent from equation (2), when the amount of the current IDS is increased, the rate RS of change of the potential VS over time is increased. In other words, when the rate RS of change of the potential VS over time becomes lower than the rate RX of change of the potential VX over time, the rate RS of change of the potential VS over time is increased.

As shown by a portion b of FIG. 2, when the rate RX of change of the potential VX of the driving signal X over time becomes lower than the rate RS of change of the potential VS of the source over time, the voltage VGS that is applied across the gate and source of the driving transistor TDR is reduced over time and the amount of the current IDS is reduced, as is apparent from equation (1). When the amount of the current IDS is reduced, the rate RS of change of the potential VS over time is reduced. In other words, when the rate RS of change of the potential VS over time exceeds the rate RX of change of the potential VX over time, the rate RS of change of the potential VS over time is reduced.

The rate RS of change of the potential VS of the source of the driving transistor TDR over time approaches the rate RX of change of the potential VX of the driving signal X over time and finally reaches the rate RX of change of the potential VX over time, regardless of characteristics of the driving transistor TDR (or regardless of whether the driving transistor TDR has the characteristics Pa or the characteristics Pb). The state in which the rate RS of change of the potential VS over time is equal to the rate RX of change of the potential VX over time (hereinafter referred to as an equilibrium state) can be also expressed by the state in which the rate of the increase (that is caused by the increase in the potential VX of the driving signal X) in the voltage VGS is equal to the rate of the reduction (that is caused by the charging with the current IDS) in the voltage VGS.

Since the rate RS of change of the potential VS over time is equal to the rate RX of change of the potential VX over time in the equilibrium state (RS=dVS/dt=RX=dVX/dt), equation (2) is expressed by the following equation (3). That is, the amount of the current IDS that flows in the driving transistor TDR is proportional to the rate RX of change of the potential VX of the driving signal X over time. Specifically, the amount of the current IDS is determined only on the basis of the capacitance cp1 of the capacitor CE and the rate RX of change of the potential VX over time and does not depend on the mobility μ of the driving transistor TDR and the threshold voltage VTH of the driving transistor TDR.

$$\begin{matrix}IDS = cp 2 \cdot ( d VS / d t - d VX / d t ) + cp 1 \cdot d vs / d t \\ = cp 2 \cdot ( d VX / d t - d VX / d t ) + cp 1 \cdot d VX / d t \\ = cp 1 \cdot RX\end{matrix} \qquad ( 3 )$$

The voltage VGS that is applied across the gate and source of the driving transistor TDR is automatically set (on the basis of the mobility μ of the driving transistor TDR and the threshold voltage VTH of the driving transistor TDR) to a voltage (that satisfies the relationship of equation (1) in which the current IDS is expressed by equation (3)) that is necessary for the current IDS (that does not depend on the mobility μ and the threshold voltage VTH and is expressed by equation (3)) to flow in the driving transistor TDR. For example, when the driving transistor TDR has the characteristics Pa shown in FIG. 2, the voltage VGS is set to a voltage Va. When the driving transistor TDR has the characteristics Pb shown in FIG. 2, the voltage VGS is set to a voltage Vb. In the equilibrium state, the current IDS that is determined only on the basis of the capacitance cp1 and the rate RX of change of the potential VX over time flows in the driving transistor TDR regardless of whether the driving transistor TDR has the characteristics Pa or the characteristics Pb.

The voltage VGS that is applied across the gate and source of the driving transistor TDR in the aforementioned manner is stored in the capacitor CST. Thus, the current IDS continuously flows in the driving transistor TDR after the supply of the driving signal X (potential VX) is stopped. As described later, in the embodiment, the current IDS is used as a current (hereinafter referred to as a driving current) IDR that is used to drive a light emitting element. As described with reference to equation (3), the current IDS does not depend on the characteristics (mobility μ and threshold voltage VTH) of the driving transistor TDS. Thus, a variation in the amount of the driving current IDR (or a variation in the brightness of the light emitting element), which is caused by the characteristics of the driving transistor TDS, can be compensated for. On the other hand, the driving current IDR (current IDS) is determined on the basis of the rate RX of change of the potential VX of the driving signal X over time. Thus, the amount of the driving current IDR (and the brightness of the light emitting element) can be variably set by controlling the rate RX of change of the potential VX of the driving signal X over time.

The following describes the correlation between the rate RX of change of the potential VX of the driving signal X[j] over time and a time period that is necessary for the potential VS of the source of the driving transistor TDR to reach the equilibrium state (i.e., a time period that is necessary for the rate RS of change of the potential VS over time to become equal to the rate RX of change of the potential VX of the driving signal X[j] over time).

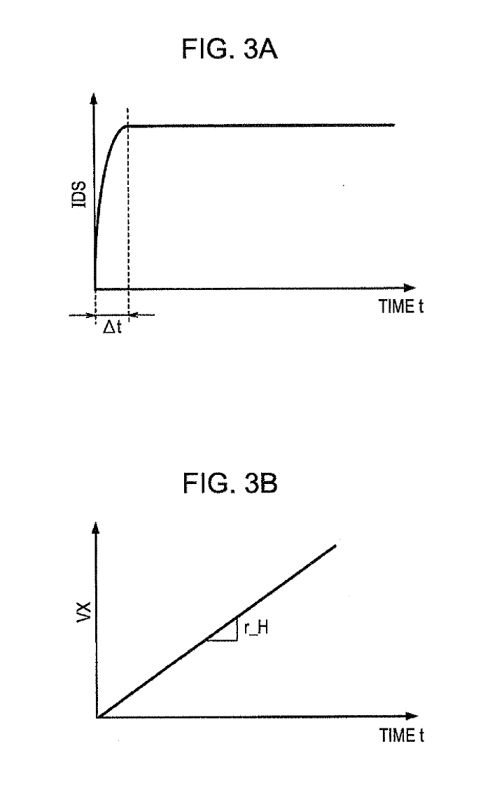

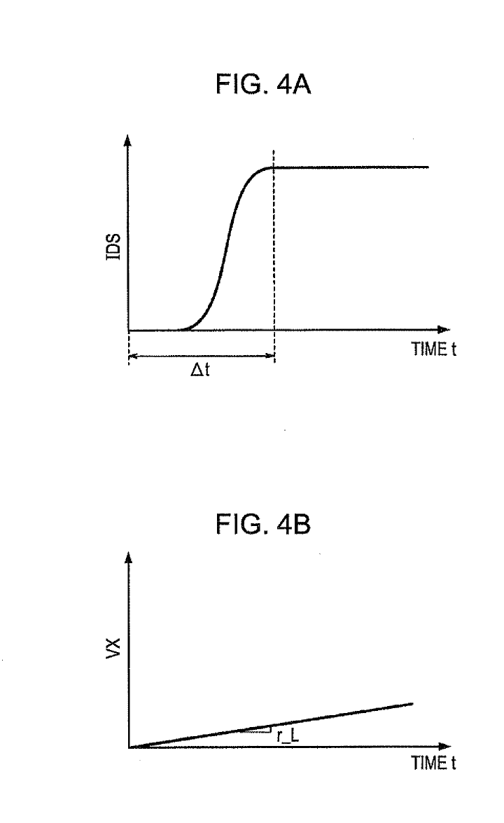

FIG. 3A is a graph showing the current IDS that flows between the drain and source of the driving transistor TDR, while FIG. 3B is a graph showing the rate RX of change of the potential VX of the driving signal VX over time. FIG. 4A is a graph showing the current IDS that flows between the drain and source of the driving transistor TDR, while FIG. 4B is a graph showing the rate RX of change of the potential VX of the driving signal X over time. FIG. 3A shows that the current IDS is changed over time in the case where the potential VX is changed over time at a rate RX (r_H) (shown in FIG. 3B) that corresponds to a relatively high intermediate gradation DH. FIG. 4A shows that the current IDS is changed over time in the case where the potential VX is changed over time at a rate RX (r_L) (shown in FIG. 4B) that corresponds to a relatively low intermediate gradation DL. In both cases shown in FIGS. 3A and 3B and shown in FIGS. 4A and 4B, the voltage VGS that is applied across the gate and source of the driving transistor TDR is set to a value that is close to the threshold voltage VTH at the time (left edge of the graph) when the potential VX starts to be changed. Thus, the amount of the current IDS is zero when the potential VX starts to be changed.

As is apparent from equation (3), the amount of the current IDS becomes stable at a predetermined value (that corresponds to the rate RX of change of the potential VX of the driving signal X[j] over time) when the potential VS of the Source of the driving transistor TDR reaches the equilibrium state after the start of the change in the potential VX of the driving signal X[j]. As is apparent from comparison of FIG. 3A with FIG. 4A, as the rate RX of change of the potential VX over time is lower, the time ΔT that is necessary for the driving transistor TDR to reach the equilibrium state is longer. The embodiment of the invention is described below in consideration of the above explanation.

### B: Configuration and Operations of Light Emitting Device

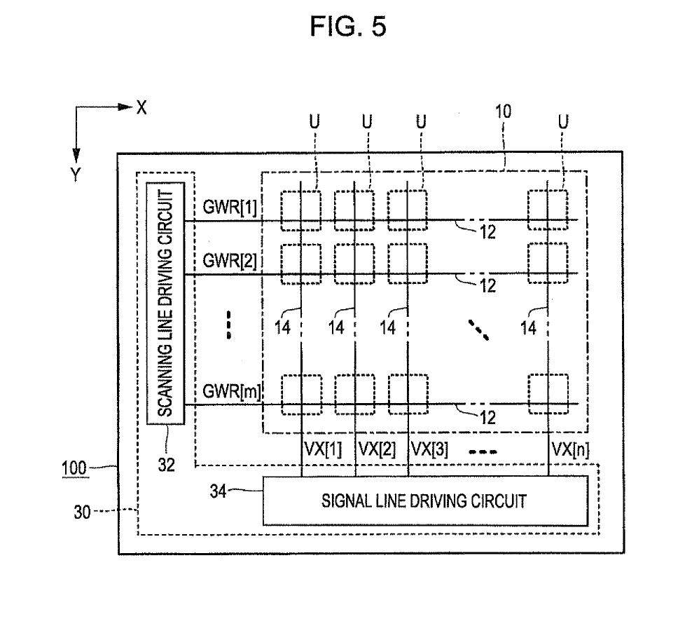

FIG. 5 is a block diagram showing a light emitting device according to the embodiment of the invention. The light emitting device 100 is mounted on an electronic device as a display device and displays an image. As shown in FIG. 5, the light emitting device 100 includes an element section 10. The element section 10 has a plurality of pixel circuits U and a driving circuit 30 that drives each pixel circuit U. The driving circuit 30 includes a scanning line driving circuit 32 and a signal line driving circuit 34. The driving circuit 30 has a plurality of integrated circuits arranged therein. The integrated circuits are separated from each other. At least a part of the driving circuit 30 may be constituted by a thin film transistor that is formed on a substrate on which the pixel circuits U are mounted.

The element section 10 includes a number m of scanning lines 12 that extend in an X direction; and a number n of signal lines 14 that extend in a Y direction that intersects the X direction (m and n are natural numbers). The pixel circuits U are located at points at which the scanning lines 12 intersect the signal lines 14. The pixel circuits U are arranged in n columns and m rows.

The scanning line driving circuit 32 sequentially selects a plurality of pixel circuits U for each row. Specifically, the scanning line driving circuit 32 sequentially selects each scanning line (group of n pixel circuits arranged in a row) by sequentially setting potentials of scanning signals GWR[1] to GWR[m] to a selection potential (active level) VSL at the start times of m unit time periods H (H[1] to H[m]) that are included in a vertical scanning period. The potentials of the scanning signals GWR[1] to GWR[m] are changed over time for the unit time periods H. Specifically, the potentials of the scanning lines GWR[1] to GWR[m] are set to the selection potential VSL at the start times ts of the unit time periods H (H[1] to H[m]). The potentials of the scanning lines GWR[1] to GWR[m] are changed at a constant rate from the start times ts to end times to of the unit time periods H (H[1] to H[m]). Each of the scanning signals GWR[1] to GWR[m] is a voltage signal that forms a ramp waveform (saw-tooth waveform) for the unit time period H. The scanning lines 12 are selected for the respective unit time periods H[1] to H[m]. The unit time periods H[1] to H[m] are hereinafter referred to as writing periods PWRT.

The signal line driving circuit 34 shown in FIG. 5 generates data potentials VX[1] to VX[n] that correspond to gradations specified for the n pixel circuits U that are arranged in one row and are selected by the scanning line driving circuit 32 for each of the unit time periods H[1] to H[m]. The signal line driving circuit 34 then outputs the data potentials VX[1] to VX[n] to the signal lines 14. For example, for the signal line 14 that is arranged in the j-th (j is any number from 1 to n) column, the signal line driving circuit 34 generates a data potential VX[j] that is changed over time for the unit time period H. The signal line driving circuit 34 then outputs the data potential VX[j] to the signal line 14 that is arranged in the j-th column. The data potential VX[j] is set to a reference potential VRS at the start time ts of the unit time period H and is linearly increased over time at a rate RX (=dVX/dt) from the start time ts to the end time to of the unit time period H. The data potential VX[j] is a voltage signal that forms a ramp waveform (saw-tooth waveform) for the unit time period H. A rate RX [i, j] indicates a rate of change of the data potential VX[j] (that is to be supplied to the signal line 14 that is arranged in the j-th column) over time for the unit time period H[i] for which the scanning line 12 that is arranged in the i-th (i is any number from 1 to m) row is selected. The rate RX[i, j] of change of the data potential VX[j] is variably set on the basis of a gradation specified for the pixel circuit U that is arranged in the i-th row and the j-th column. The same applies to the data potentials VX that are to be output to the other signal lines 14.

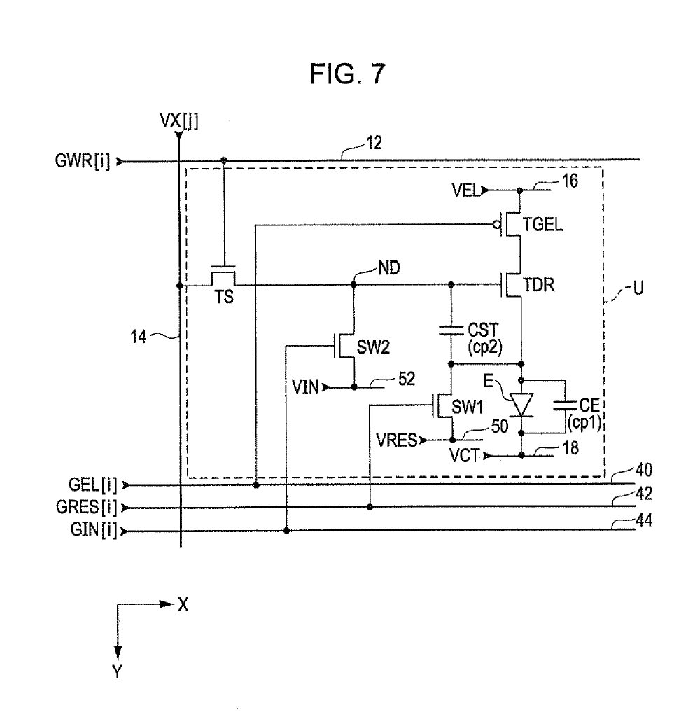

FIG. 7 is a diagram showing the pixel circuit U. In FIG. 7, the pixel circuit U that is arranged in the i-th row and j-th column is shown as a representative example. As shown in FIG. 7, the element section 10 has first control lines 40 that extend in X direction and are arranged in a one-to-one relationship with the m scanning lines 12; second control lines 42 that extend in X direction and are arranged in a one-to-one relationship with the m scanning lines 12; and third control lines 44 that extend in X direction and are arranged in a one-to-one relationship with the m scanning lines 12. The driving circuit 30 (e.g., scanning line driving circuit 32) supplies predetermined signals to the respective first, second and third control lines 40 42 and 44. Specifically, a light emission control signal GEL[i] is supplied to the first control line 40; a reset signal GRES[i] is supplied to the second control line 42; and an initialization signal GIN[i] is supplied to the third control line 44.

As shown in FIG. 7, each pixel circuit U includes a light emitting element E, a driving transistor TDR, a light emission control transistor TGEL, a storage capacitor CST, a selecting transistor TS, a first switching element SW1 and a second switching element SW2. The light element E, the driving transistor TDR and the light emission control transistor TGEL are connected to each other in series on a line that connects a feeding line 16 to a feeding line 18. A high potential VEL is supplied to the feeding line 16, while a low potential VCT (<VEL) is supplied to the feeding line 18. The light emitting element E is an organic EL element and includes an anode, a cathode (arranged opposite the anode) and a light emitting layer (made of an organic electroluminescence material and arranged between the anode and the cathode). As shown in FIG. 7, a capacitor CE (having a capacitance cp1) is provided for the light emitting element E.

The light emission control transistor TGEL is a P-channel transistor (e.g., thin film transistor). A source of the light emission control transistor TGEL is connected to the feeding line 16, while a drain of the light emission control transistor TGEL is connected to the driving transistor TDR. A gate of the light emission control transistor TGEL is connected to the first control line 40. The driving transistor TDR is an N-channel transistor. A drain of the driving transistor TDR is connected to the light emission control transistor TGEL, while a source of the driving transistor TDR is connected to the anode of the light emitting element E. The storage capacitor CST (having a capacitance cp2) is located between the gate of the driving transistor TDR and the source of the driving transistor TDR (or is located on a line that connects the driving transistor TDR to the light emitting element E).

The selecting transistor TS is an N-channel transistor and is located between the signal line 14 and the gate of the driving transistor TDR. A gate of the selecting transistor TS is connected to the scanning line 12. The first switching element SW1 is an N-channel transistor and is located between a reset line 50 and the source of the driving transistor TDR. A reset potential VRES is supplied to the reset line 50. A gate of the first switching element SW1 is connected to the second control line 42. The second switching element SW2 is an N-channel transistor and is located between a node ND and an initialization line 52. An initialization potential VST is supplied to the initialization line 52. The node ND is located between the driving transistor TDR and the selecting transistor TS. A gate of the second switching element SW2 is connected to the third control line 44.

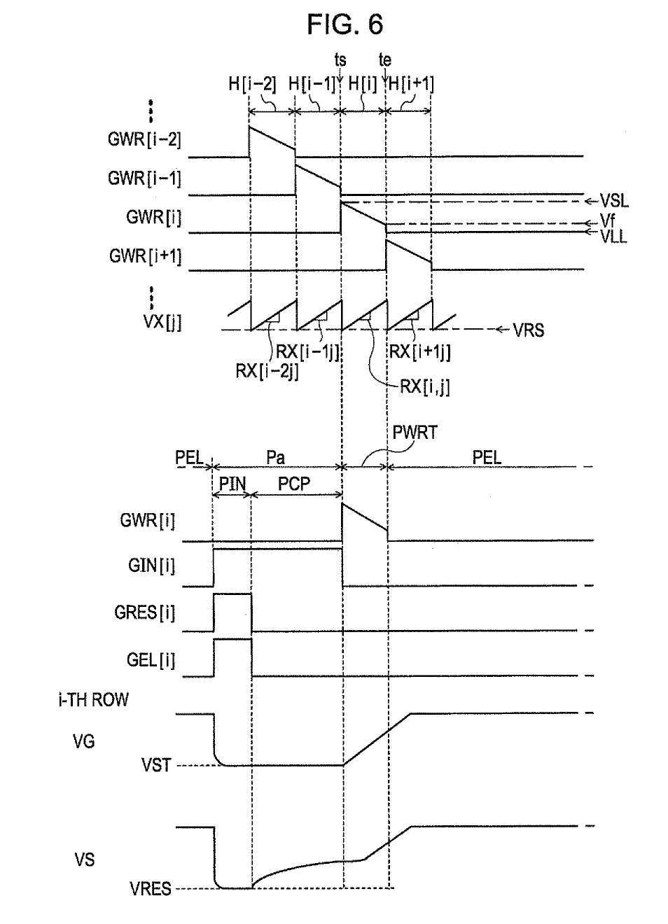

The waveforms of signals that are used in the light emitting device 100 are described below with reference to FIG. 6. As shown in FIG. 6, the initialization signal GIN[i] is set to an active level (high level) for a time period (hereinafter referred to as an operating period) Pa that ends immediately before the writing period PWRT (i-th unit time period H[i]) for which the scanning line 12 that is arranged in the i-th row is selected. The initialization signal GIN[i] is set to a non-active level (low level) for the other time periods. As shown in FIG. 6, the operating period Pa is divided into an initialization period PIN and a compensation period PCP that starts after the initialization period PIN. The initialization period PIN is provided in order to initialize a voltage that is applied across the gate and source of the driving transistor TDR. The compensation period PCP is provided in order to cause the voltage applied across the gate and source of the driving transistor TDR to become asymptotic to a threshold voltage VTH of the driving transistor TDR.

The reset signal GREs[i] is set to an active level (high level) for the initialization period PIN (included in the operating period Pa) and is set to a non-active level (low level) for the other time periods. The light emission control signal GEL[i] is set to an active level (high level) for the initialization period PIN (included in the operating period Pa) and is set to a non-active level (low level) for the other time periods.

Operations of each pixel circuit U (and a method for driving each pixel circuit U) are described in detail below. The following describes operations of the pixel circuit that is arranged in the i-th row and j-th column and is operated for the initialization period PIN; operations of the pixel circuit that is arranged in the i-th row and j-th column and is operated for the compensation period PCP; operations of the pixel circuit that is arranged in the i-th row and j-th column and is operated for the writing period PWRT; and operations of the pixel circuit that is arranged in the i-th row and j-th column and is operated for a light emission period PEL. The same applies to operations of the other pixel circuits U.

### (a) Initialization Period PIN

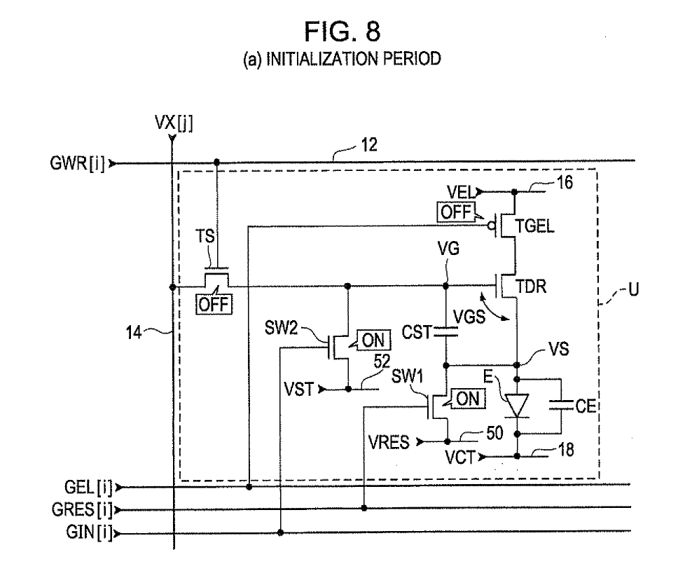

As shown in FIG. 6, the driving circuit (e.g., scanning line driving circuit 32) sets the initialization signal GIN[i], the reset signal GRES[i] and the light emission control signal GEL[i] to the high levels and sets the scanning signal GWR[i] to a low level for the initialization period PIN. Thus, the first switching element SW1 and the second switching element SW2 are in an ON state for the initialization period PIN, while the selecting transistor TS and the light emission control transistor TGEL are in an OFF state for the initialization period PIN, as shown in FIG. 8.

Since the source of the driving transistor TDR is electrically connected to the reset line 50 through the switching element SW1, the potential VS of the source of the driving transistor TDR is set to the reset potential VRES that is supplied to the reset line 50. In addition, since the gate of the driving transistor TDR is electrically connected to the initialization line 52 through the second switching element SW2, the potential VG of the gate of the driving transistor TDR is set to the initialization potential VST that is supplied to the initialization line 52. Thus, the voltage VGS that is applied across the gate and source of the driving transistor TDR is set (initialized) to a value of |VST−VRES|. In the present embodiment, the difference |VST−VRES| between the initialization potential VST and the reset potential VRES is set to a value that is larger than the threshold potential VTH of the driving transistor TDR. The reset potential VRES is set so that a difference (or voltage applied across both ends of the capacitor CE) between the reset potential VRES and the low potential VCT (that is supplied to the feeding line 18) is lower than a light emission threshold potential of the light emitting element E. Thus, the light emitting element E is in an OFF state (non-emission state) for the initialization period PIN.

### (b) Compensation Period PCP

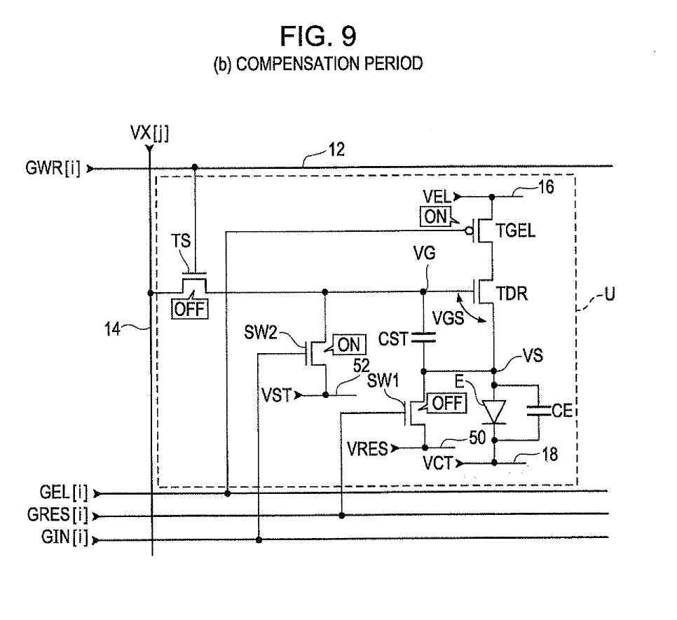

As shown in FIG. 6, when the compensation period PCP starts, the driving circuit 30 sets the reset signal GRES[i] and the light emission control signal GEL[i] to the low levels. The driving circuit 30 maintains the potentials of the other signals at the same levels as in the initialization period PIN. Thus, the first switching element SW1 is switched to an OFF state, while the light emission control transistor TGEL is switched to an ON state, as shown in FIG. 9. In this state, a current flows from the feeding line 16 through the light emission control transistor TGEL to the driving transistor TDR, and the potential VS of the source of the driving transistor TDR starts to increase. In this case, the potential VG of the gate of the driving transistor TDR is maintained at the initialization potential VST. Thus, the voltage VGS that is applied across the gate and source of the driving transistor TDR is gradually reduced and becomes asymptotic to the threshold potential VTH of the driving transistor TDR. In other words, a compensating operation is performed so that the voltage VGS that is applied across the gate and source of the driving transistor TDR becomes asymptotic to the threshold potential VTH of the driving transistor TDR during the compensation period PCP.

At the end time of the compensation period PCP, the voltage VGS applied across gate and source of the driving transistor TDR is nearly equal to the threshold potential VTH of the driving transistor TDR. Thus, the potential VS of the source of the driving transistor TDR is set to a potential (VST−VTH) that is lower by the threshold potential VTH than the potential VST (potential VG of the gate of the driving transistor TDR). In the present embodiment, a difference (voltage applied across both ends of the capacitor CE) between the potential (VST−VTH) and the low potential VCT is set to a value that is lower than the light emission threshold voltage of the light emitting element E. Thus, the light emitting element E is in the OFF state (non-emission state) for the compensation period PCP.

### (c) Writing Period PWRT

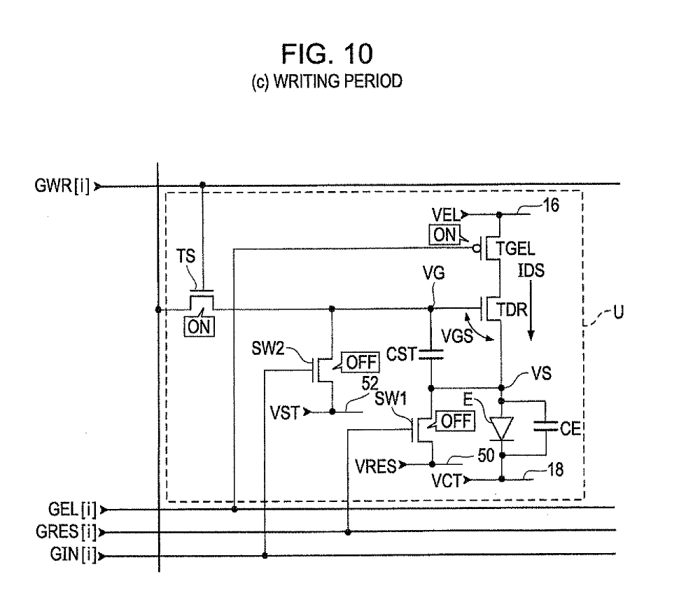

As shown in FIG. 6, when the writing period PWRT starts, the driving circuit 30 sets the potential of the scanning signal GWR[i] to the selection potential (active level) and sets the initialization signal GIN[i] to the low level. The driving circuit 30 maintains the other signals at the same levels as in the compensation period PCP. Thus, the selecting transistor TS is switched to an ON state, while the second switching element SW2 is switched to an OFF state, as shown in FIG. 10. Therefore, the gate of the driving transistor TDR is electrically connected to the signal line 14. The data potential VX[j] is supplied to the gate of the driving transistor TDR. The potential VG of the gate of the driving transistor TDR is increased over time at the rate RX[i, j] that corresponds to the gradation specified for the pixel circuit U. The current IDS that corresponds to the potential VG of the gate flows between the drain and source of the driving transistor TDR. Thus, the potential VS of the source is increased over time. When the rate RS (=dVS/dt) of change of the potential VS of the source over time becomes equal to the rate RX[i, j] of change of the data potential VX[j] over time or reaches the equilibrium state, the current IDS that depends only on the capacitance cp1 of the capacitor CE (that is provided for the light emitting element E) and the rate RX[i, j] of change of the potential VX[j] over time flows in the driving transistor TDR.

After the driving circuit 30 (e.g., the scanning line driving circuit 32) sets the potential of the scanning signal GWR[i] to the selection potential (active level) VSL, the driving circuit 30 (e.g., the scanning line driving circuit 32) changes the potential of the scanning signal GWR[i] over time from the selection potential VSL for the predetermined period that lasts until the end time te of the writing period PWRT so that the selecting transistor TS is switched to an OFF state to stop the supply of the data potential VX[j] to the driving transistor TDR. Details of this are described below.

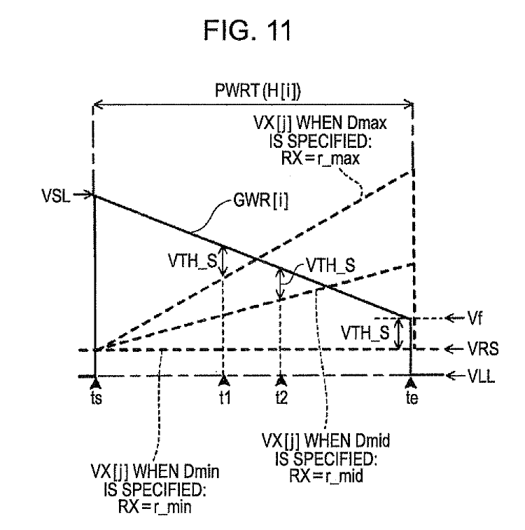

FIG. 11 is a diagram showing the relationship between the potential of the scanning signal GWR[i] and the data potential VX[j], which are supplied for the writing period PWRT. As shown in FIG. 11, the potential of the scanning signal GWR[i] is set to the selection potential VSL at the start time ts of the writing period PWRT and is reduced over time at a constant rate from the start time ts to the end time te of the writing period PWRT. The potential of the scanning signal GWR[i] is changed from a potential Vf (that is lower than the selection potential VSL and is set immediately before the end time te) to a potential VLL (that is a non-active level (low level)) at the end time te. On the other hand, the data potential VX[i] is set to the reference potential VRS at the start time is of the writing period PWRT and is linearly increased for the writing period PWRT (from the start time is to the end time te). The rate RX[i, j] of change of the data potential VX[j] over time is variably set on the basis of the gradation specified for the pixel circuit U. As the specified gradation is higher, the gradient of the data potential VX[j] is steeper. For example, as shown in FIG. 11, when the specified gradation is the minimum gradation Dmin (displaying in black), the rate RX[i, j] of change of the data potential VX[j] over time is set to the minimum value r_min (zero). In this case, the data potential VX[j] is not changed and is maintained at the reference potential VRS for the writing period PWRT. On the other hand, when the specified gradation is the maximum gradation Dmax (displaying in white), the rate RX[i, j] of change of the data potential VX[j] over time is set to the maximum value r_max. In addition, when the specified gradation is an intermediate gradation Dmid, the rate RX[i, j] of change of the data potential VX[j] over time is set to a value r_mid (r_min<r_mid<r_max).

The driving circuit 30 (scanning line driving circuit 32 and signal line driving circuit 34) generates the data potential VX[j] and the scanning signal GWR[i] so that a difference between the scanning signal GWR[i] and the data potential VX[i] becomes lower than a threshold voltage VTH_S of the selecting transistor TS during the writing period PWRT. As shown in FIG. 11, a time period that starts from the start time ts of the writing period PWRT and is necessary for the difference between the scanning signal GWR[i] and the data potential VX[i] to become lower than the threshold voltage VTH_S of the selecting transistor TS varies depending on the specified gradation. In the present embodiment, as the specified gradation is higher, the time period (that starts from the start time ts of the writing period PWRT and is necessary for the difference between the scanning signal GWR[i] and the data potential VX[i] to become lower than the threshold voltage VTH_S of the selecting transistor TS) is shorter. The details are described below.

In the present embodiment, a difference between the potential Vf (that is set immediately before the end time to of the writing period PWRT) of the scanning signal GWR[i] and the reference potential VRS for the data potential VX[j] is set to a value that is substantially equal to the threshold voltage VTH_S of the selecting transistor TS. When the minimum gradation Dmin is specified, the selecting transistor TS is switched to the OFF state immediately before the end time te of the writing period PWRT. On the other hand, when the maximum gradation is specified, the difference between the data potential VX[j] and the potential of the scanning signal GWR[i] becomes substantially equal to the threshold voltage VTH_S at a time t1 before the end time te, and the selecting transistor TS is switched to the OFF state at the time t1, as shown in FIG. 11. When the intermediate gradation Dmid is specified, the difference between the data potential VX[j] and the potential of the scanning signal GWR[i] becomes substantially equal to the threshold voltage VTH_S at a time t2 after the time t1 and before the end time te, and the selecting transistor TS is switched to the OFF state at the time t2, as shown in FIG. 11.

The driving circuit 30 (scanning line driving circuit 32 and signal line driving circuit 34) generates the data potential VX[j] and the scanning signal GWR[i] so that the time period (that is necessary for the selecting transistor TS to be switched to the OFF state) that starts from the start time is of the writing period PWRT and is necessary for the difference between the data potential VX[j] and the scanning signal GWR[i] to become lower than the threshold voltage VTH_S is longer than the time period Δt (shown in FIGS. 3A and 4A) that is necessary for the driving transistor TDR to reach the equilibrium state. Thus, there is an advantage that the driving transistor TDR can reliably reach the equilibrium state (in which the rate RS of change of the potential VS of the source of the driving transistor TDR over time is equal to the rate RX of change of the data potential VX[j] over time) during the writing period PWRT. As described with reference to FIGS. 3A to 4B, as the rate RX of change of the data potential VX[j] over time is higher (or the specified gradation is higher), the time period Δt (that is necessary for the driving transistor TDR to reach the equilibrium state) is shorter. Thus, the driving transistor TDR can reliably reach the equilibrium state although the time that is necessary to supply the data potential VX[j] is shorter as the specified gradation is higher.

As described above, the selecting transistor TS is switched to the OFF state so that the supply of the data potential VX[j] to the gate of the driving transistor TDR is stopped. Then, a voltage VSET that corresponds to the current IDS (that flows in the driving transistor TDR at the time when the supply of the data potential VX[j] is stopped) is stored in the storage capacitor CST. The voltage VSET is equal to the voltage VGS that is applied across the gate and source of the driving transistor TDR and is necessary for the current IDS (that is expressed by equation (3) and is determined on the basis of the capacitance cp1 of the capacitor CE and the rate RX[i, j] of change of the data potential VX[j] over time) to flow in the driving transistor TDR. The voltage VSET is automatically set on the basis of characteristics such as the mobility μ of the driving transistor TDR and the threshold voltage VTH of the driving transistor TDR (refer to A: Driving principles). The driving circuit 30 sets the waveform of the data potential VX[j] and the waveform of the scanning signal GWR[i] so that the rate RX[i, j] of change of the data potential VX[j] over time at the time when the supply of the data potential VX[j] to the gate of the driving transistor TDR is stopped is equal to a value that corresponds to the gradation specified for the pixel circuit U.

In the present embodiment, the selecting transistor TS is switched to the OFF state before the end time to of the writing period PWRT. Since the voltage VSET is stored in the storage capacitor CST, the current IDS that corresponds to the voltage VSET continuously flows in the driving transistor TDR. Thus, the potential VS of the source of the driving transistor TDR is increased over time. In this case, the selecting transistor TS is in the OFF state. Thus, the gate of the driving transistor TDR becomes in an electrically floating state, and the potential VG of the gate of the driving transistor TDR is increased with the increase in the potential VS of the source. Specifically, while the potential VGS that is applied across the gate and source of the driving transistor TDR is maintained at the potential VSET, the voltage (potential VS of the source of the driving transistor TDR) that is applied across both ends of the capacitor CE is gradually increased. In the present embodiment, the potential VS of the source of the driving transistor TDR at the end time to of the writing period PWRT is set so that the voltage applied across both ends of the capacitor CE is lower than the light emission threshold voltage of the light emitting element E. Thus, the light emitting element E is in the OFF state (non-emission state) for the writing period PWRT.

### (d) Light Emission Period PEL

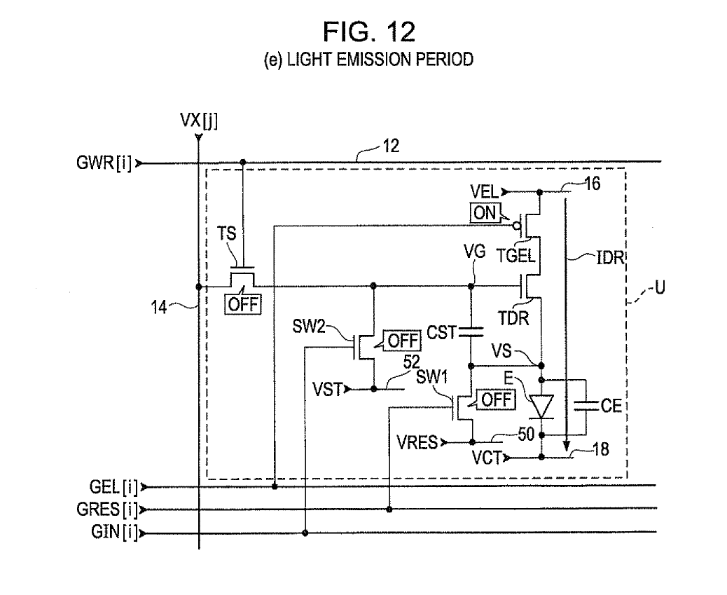

As shown in FIG. 6, the driving circuit 30 sets the potential of the scanning signal GWR[i] to the potential VLL (that is the non-active level (low level)) for the light emission period PEL. The driving circuit 30 maintains the potentials of the other signals at the same levels as in the writing period PWRT. Thus, the selecting transistor TS is reliably set to the OFF state, as shown in FIG. 12. In addition, since the light emission control transistor TGEL is maintained in the ON state, the current IDS that corresponds to the voltage VSET stored in the storage capacitor CST flows in the driving transistor TDR. Thus, the potential VS of the source of the driving transistor TDR is increased over time.

In this case, since the gate of the driving transistor TDR is in the electrically floating state, the potential VG of the gate of the driving transistor TDR is increased with the increase in the potential VS of the source of the driving transistor TDR. Then, the voltage (potential VS of the source of the driving transistor TDR) that is applied across both ends of the capacitor CE (that is provided for the light emitting element E) is gradually increased while the voltage VGS (voltage applied across both ends of the storage capacitor CST) that is applied across the gate and source of the driving transistor TDR is maintained at the voltage VSET that is set during the writing period PWRT. When the voltage that is applied across both ends of the capacitor CE reaches the light emission threshold voltage of the light emitting element E, the current IDS (that does not depend on the mobility μ of the driving transistor TDR and the threshold voltage VTH of the driving transistor TDR) that corresponds to the voltage VSET flows in the light emitting element E as the driving current IDR. The light emitting element E emits light having an intensity that corresponds to the amount of the driving current IDR.

The amount of the driving current IDR that is supplied to the light emitting element E is maintained at the same amount as the current IDS that flows in the driving transistor TDR when the supply of the data potential VX[j] is stopped. Since the current IDS depends on the rate RX [i, j] (of change of the data potential VX[j] over time) that is variably set on the basis of the specified gradation (equation (3)), the driving current IDR having an amount that corresponds to the specified gradation is supplied to the light emitting element E. In this manner, the driving current IDR that corresponds to the rate RX[i, j] (specified gradation) of change of the data potential VX[j] over time for the i-th writing period PWRT (unit time period H[i]) is supplied to the light emitting element E that is included in the pixel circuit U arranged in the i-th row and the j-th column.

In the aforementioned embodiment, the voltage VSET that is applied across both ends of the storage capacitor CST is set so that the current IDS (that does not depend on the mobility μ of the driving transistor TDR and the threshold voltage VTH of the driving transistor TDR) that corresponds to the rate RX[i, j] of change of the data potential VX[j] over time flows in the driving transistor TDR. Thus, it is possible to suppress a variation (that is caused by the characteristics (the mobility μ of the driving transistor TDR and the threshold voltage VTH of the driving transistor TDR) of the driving transistor TDR) in the driving current IDR (and suppress a variation in the intensity of light emitted by the light emitting element E). Thus, there is an advantage that a variation in the gradation of an image that is displayed by the element section 10 can be suppressed.

It is assumed that the potentials of the scanning signals GWR[1] to GWR[m] are maintained at the selection potential VSL (without being changed over time) for the writing period PWRT from the start time is to the end time to in an example (hereinafter referred to as a comparative example) in a different manner from the aforementioned embodiment. In the comparative example, the scanning signal GWR[i] is a voltage signal that has a selection pulse PSL (of the selection potential) that is applied for the i-th writing period PWRT (unit time period H[i]). The i-th writing period PWRT is included in the vertical scanning time period. Other configurations are the same as the aforementioned embodiment and are not described below.

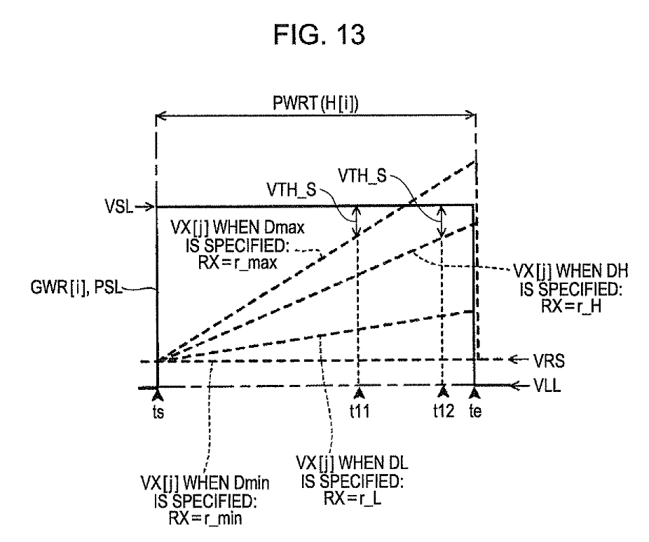

FIG. 13 is a diagram showing the relationship between the potential of the scanning signal GWR[i] and the data potential VX[j], which are supplied for the i-th writing period PWRT (unit time period H[i]) in the comparative example. In the comparative example, when a gradation (bright level) that is higher than a predetermined value is specified, the waveform of the data potential VX[j] is selected so that the difference between the data potential VX[j] and the selection potential VSL becomes lower than the threshold voltage VTH_SL of the selecting transistor TS during the writing period PWRT (unit time period H[i]) (before the end of the selection pulse PSL). In other words, when the maximum gradation Dmax or a high gradation DH that is higher than the predetermined value is specified, the selecting transistor TS is switched to the OFF state before the end of the selection pulse PSL (during the writing period PWRT). As shown in FIG. 13, when the maximum gradation Dmax is specified, the difference between the data potential VX[j] and the potential of the scanning signal GWR[i] becomes substantially equal to the threshold voltage VTH_S at a time t11 before the end time te, and the selecting transistor TS is switched to the OFF state at the time t11. When the high gradation DH is specified, the difference between the data potential VX[j] and the potential of the scanning signal GWR[i] becomes substantially equal to the threshold voltage VTH_S at a time t12 after the time t11 and before the end time te, and the selecting transistor TS is switched to the OFF state at the time 12. When a gradation that is higher than the predetermined value is specified and the selecting transistor TS is switched to the OFF state, the potential of the scanning signal GWR[i] is maintained at the selection potential VSL.

On the other hand, when a gradation (dark level) that is lower than the predetermined value is specified, the waveform of the data potential VX[j] is selected so that the difference between the data potential VX[j] and the selection potential VSL becomes higher than the threshold voltage VTH_S of the selecting transistor TS at the end time te of the writing period PWRT. Thus, when the minimum gradation Dmin or a low gradation DL that is lower than the predetermined value is specified, the potential of the scanning signal GWR[i] is quickly changed from the selection potential VSL to the potential VLL (non-active level) at the end time te (end of the selection pulse PSL) of the writing period PWRT so that the selecting transistor TS is switched to the OFF state. In this case, the potential VG of the gate of the driving transistor TDR is changed (reduced) at the end time te of the writing period PWRT due to a feed-through effect that occurs when the potential of the scanning signal GWR[i] is quickly changed (reduced) from the selection potential VSL to the potential VLL at the end time te of the writing period PWRT in order to change the state of the selecting transistor TS to the OFF state. The amount of the change (reduction) in the potential VG is larger as the amount of the change in the potential of the scanning signal GWR[i] when the selecting transistor TS is switched to the OFF state is larger. Thus, the amount of the change in the potential VG in the case where a gradation (dark level) that is lower than the predetermined value is specified is larger than the amount of the change in the potential VG in the case where a gradation (bright level) that is higher than the predetermined value is specified. When a gradation (dark level) that is lower than the predetermined value is specified, it is difficult to set the brightness of the pixel to a desired gradation.

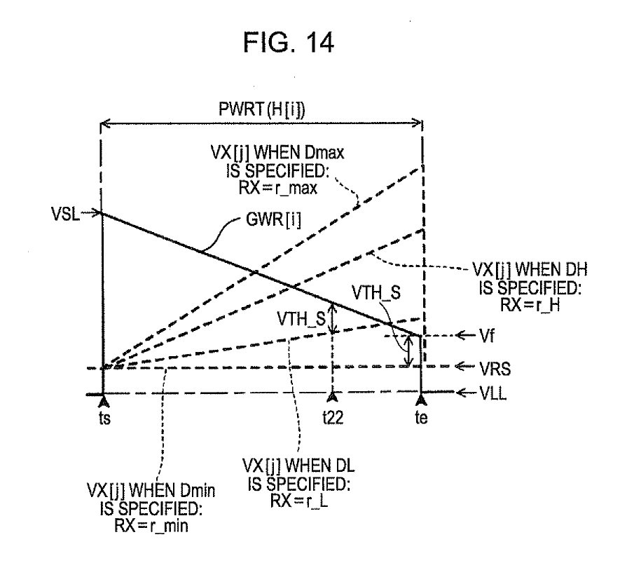

On the other hand, in the present embodiment, the potential of the scanning signal GWR[i] is changed over time from the selection potential VSL for the writing period PWRT (from the start time is to the end time te) so that the selecting transistor TS is switched to the OFF state during the writing period PWRT regardless of the specified gradation. For example, when the low gradation DL is specified, the difference between the data potential VX[j] and the potential of the scanning signal GWR[i] becomes substantially equal to the threshold voltage VTH_S at a time 22 before the end time te of the writing period PWRT, and the selecting transistor TS is switched to the OFF state at the time t22, as shown in FIG. 14. The amount of the change in the potential of the scanning signal GWR[i] at the time 22 (when the selecting transistor TS is switched to the OFF state) is sufficiently smaller than the amount of the change (=VSL−VLL) in the potential of the scanning signal GWR[i] described in the comparative example. Thus, the amount of a change (reduction) (that is caused by a feed-through effect that occurs when the selecting transistor TS is switched to the OFF state) in the potential VG can be suppressed compared with the comparative example. The same applies to the case in which the minimum gradation Dmin is specified. In the present embodiment, even when a gradation (e.g., the low gradation DL or the minimum gradation Dmin) that is lower than the predetermined value is specified, the amount of the change in the potential of the scanning signal GWR[i] at the time 22 (when the selecting transistor TS is switched to the OFF state) can be smaller than the comparative example. It is, therefore, possible to suppress a deviation of the brightness of the pixel from a desired target value.

In the present embodiment, even when a gradation that is lower than the predetermined value is specified and the potential of the scanning signal GWR[i] and the data potential VX[j] are set so that the difference between the potential of the scanning signal GWR[i] and the data potential VX[j] is higher than the threshold potential VTH_S of the selecting transistor TS at the end time to of the writing period PWRT (or so that the selecting transistor TS is maintained in the ON state), the potential of the scanning signal GWR[i] is linearly reduced from the start time is to the end time te of the writing period PWRT and is set lower than the selection potential VSL at the end time te of the writing period PWRT. The potential of the scanning signal GWR[i] is changed to the potential VLL (non-active level) at the end time te of the writing period PWRT so that the selecting transistor TS is switched to the OFF state. In this case, the amount of the change in the potential of the scanning signal GWR[i] is smaller than the amount of the change (=VSL−VLL) described in the comparative example. Even in this case, it is possible to suppress the amount of the change (reduction) (that is caused by the feed-through effect that occurs when the selecting transistor TS is switched to the OFF state) in the potential VG.

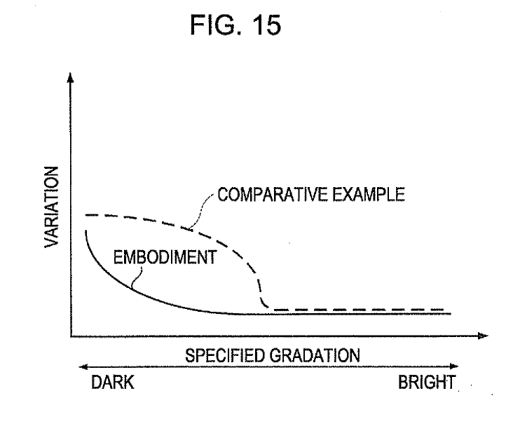

FIG. 15 is a diagram showing the relationship between gradations specified for a plurality of pixels (pixel circuits U) that are included in a specific region of the element section 10 and a variation in the brightness of the pixels. In FIG. 15, the abscissa represents the gradation specified for each pixel, and the ordinate represents the variation in the brightness of the pixels. The variation represented by the ordinate of FIG. 15 is defined by the relationship of ((the maximum value of the brightness of the pixels)−(the minimum value of the brightness of the pixels)/(the average value of the brightness of the pixels). As is understood from FIG. 15, the variation in the brightness of the pixels in the present embodiment is lower than the comparative example. This is because it is possible to suppress the amount of the change (reduction) (that is caused by the feed-through effect that occurs when the selecting transistor TS is switched to the OFF state) in the potential VG compared with the comparative example even when a low gradation (the low gradation DC that is lower than the predetermined value or the minimum gradation Dmin) is specified.

When the scanning signals GWR[1] to GWR[m] have pulse waveforms that are formed for the unit time periods H[1] to H[m], the waveform of the scanning signal GWR[i] that is supplied to a pixel circuit U located near the driving circuit 30 (e.g., scanning line driving circuit 32) is different from the waveform of the scanning signal GWR[i] that is supplied to a pixel circuit U located far from the driving circuit 30. This difference is caused by parasitic capacitance and parasitic resistance, which are associated with the scanning line 12. The total of the parasitic capacitance and the parasitic resistance (that are associated with the scanning line 12) is larger as a distance between the driving circuit 30 (e.g., scanning line driving circuit 32) and the pixel circuit U to which the scanning signal GWR[i] is supplied is longer. The waveform of the scanning signal GWR[i] that is to be supplied to the pixel circuit U located far from the driving circuit 30 is affected by the parasitic capacitance and the parasitic resistance (that are associated with the scanning line 12) and is misaligned (delayed) compared with the waveform of the scanning signal GWR[i] that is supplied to the pixel circuit U located near the driving circuit 30. The amount of the misalignment (delay) tends to be larger as the amount of the change in the potential of the scanning signal GWR[i] per unit time is larger.

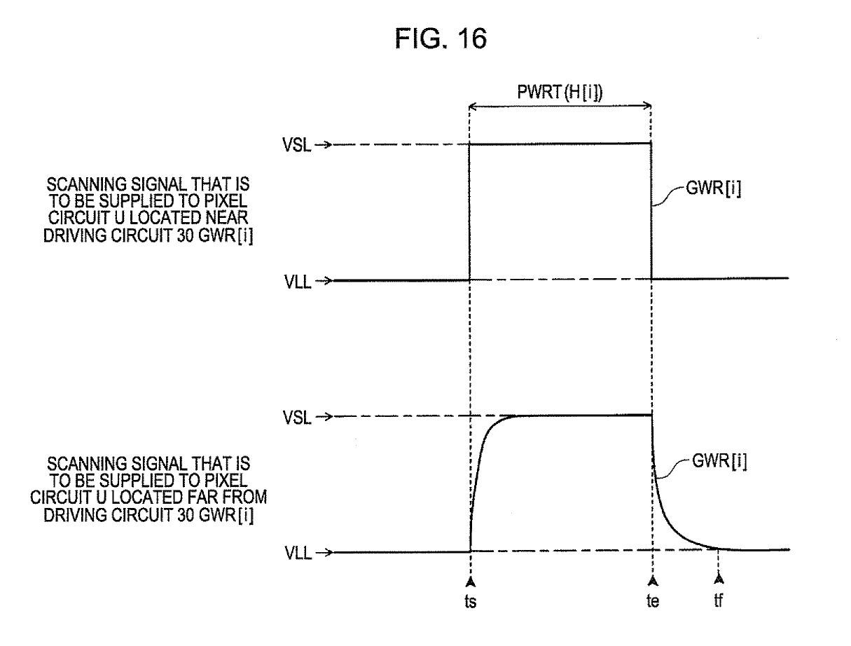

FIG. 16 is a diagram showing a comparison of the waveform of the scanning signal GWR[i] that is to be supplied to the pixel circuit U located near the driving circuit 30 with the waveform of the scanning signal GWR[i] that is to be supplied to the pixel circuit U located far from the driving circuit 30. As shown in FIG. 16, the potential of the scanning signal GWR[i] that is to be supplied to the pixel circuit U located near the driving circuit 30 is abruptly reduced from the selection potential VSL to the potential VLL (non-active level) at the end time to of the writing period PWRT. On the other hand, the potential of the scanning signal GWR[i] that is to be supplied to the pixel circuit U located far from the driving circuit 30 is affected by the parasitic capacitance and the parasitic resistance (which are associated with the scanning line 12), and the waveform of the scanning signal GWR[i] is misaligned (or delayed) when the potential of the scanning signal GWR[i] is reduced. Thus, the potential of the scanning signal GWR[i] reaches the potential VLL (non-active level) at a time tf after the end time te of the writing period PWRT.

When a gradation (low gradation DL, the minimum gradation Dmin or the like) that is lower than the predetermined value is specified in the comparative example, the potential VG of the gate of the selecting transistor is significantly changed (reduced) due to the feed-through effect (that occurs when the selecting transistor TS is switched to the OFF state) at the end time te of the writing period PWRT. In this case, a portion (that is formed when the potential of the scanning signal GWR[i] is reduced) of the waveform of the scanning signal GWR[i] that is to be supplied to the pixel circuit U located near the driving circuit 30 is different from a potion (that is formed when the potential of the scanning signal GWR[i] is reduced) of the waveform of the scanning signal GWR[i] that is to be supplied to the pixel circuit U located far from the driving circuit 30. Thus, the amount of the change (that is caused by the feed-through effect) in the potential VG of the gate of the driving transistor TDR that is included in the pixel circuit U located near the driving circuit 30 is different from the amount of the change (that is caused by the feed-through effect) in the potential VG of the gate of the driving transistor TDR that is included in the pixel circuit U located far from the driving circuit 30 in the comparative example.

On the other hand, in the present embodiment, the potential of the scanning signal GWR[i] is linearly reduced for the writing period PWRT (from the start time is to the end time te). Thus, the amount of the change in the potential of the scanning signal GWR[i] per unit time, which is represented by a portion (that is formed when the potential of the scanning signal GWR[i] falls) of the waveform of the scanning signal GWR[i] (whose potential is reduced over time from the selection potential VSL), can be suppressed compared with the comparative example. Therefore, the waveform portion (that is formed when the potential falls) of the scanning signal GWR[i] that is to be supplied to the pixel circuit U located near the driving circuit 30 can match the waveform portion (that is formed when the potential falls) of the scanning signal GWR[i] that is to be supplied to the pixel circuit U located far from the driving circuit 30. In the present embodiment, even when a gradation that is lower than the predetermined value is specified, it is possible to suppress the amount of the change (that is caused by the feed-through effect that occurs when the selecting transistor TS is switched to the OFF state) in the potential VG and suppress a difference between the amount of the change in the potential VG of the gate of the driving transistor TDR that is included in the pixel circuit U located near the driving circuit 30 and the amount of the change in the potential VG of the gate of the driving transistor TDR that is included in the pixel circuit U located far from the driving circuit 30.

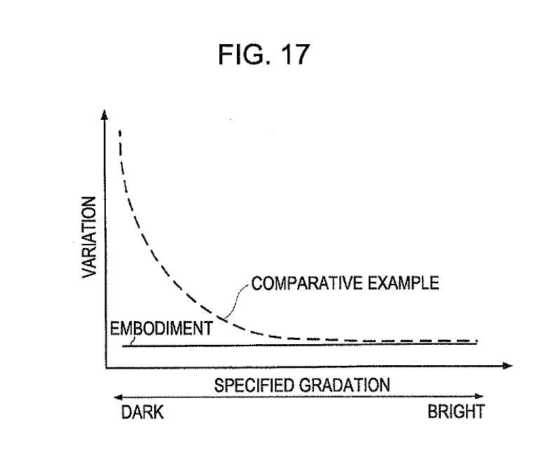

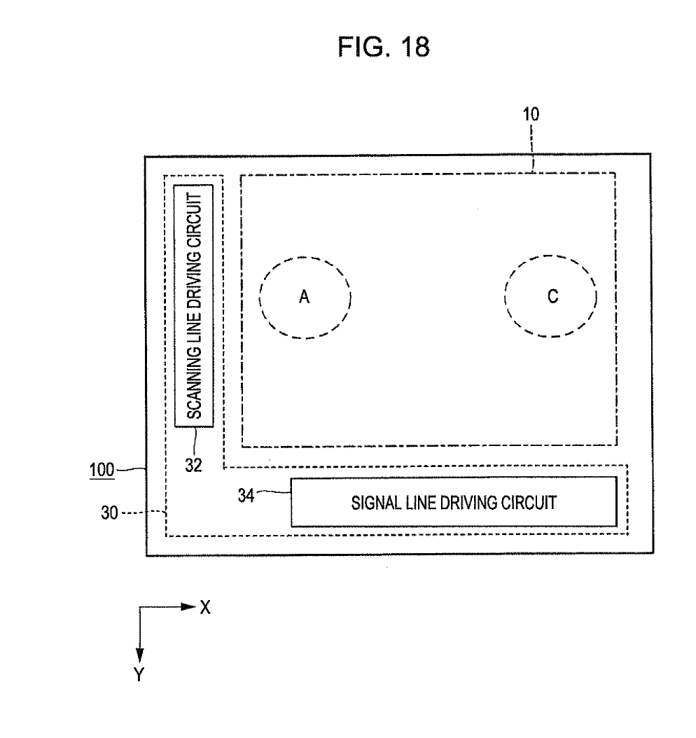

FIG. 17 is a diagram showing the relationship between gradations specified for a plurality of pixels that are included in regions A and C shown in FIG. 18 and a variation in the brightness of the regions A and C. In FIG. 17, the abscissa represents the gradation specified for each pixel, and the ordinate represents the variation in the brightness of the regions A and C. The variation represented by the ordinate of FIG. 17 is defined by the relationship of ((the average brightness of the pixels included in the region C)−(the average brightness of the pixels included in the region A)/(the average brightness of the pixels included in the region C)+(the average brightness of the pixels included in the region A)). As shown in FIG. 18, the region A that is included in the element section 10 is located nearer the scanning line driving circuit 32 than the region C that is included in the element section 10. In other words, a distance between the scanning line driving circuit 32 and the region A, which is measured in X direction, is smaller than a distance between the scanning line driving circuit 32 and the region C, which is measured in X direction.

As is understood from FIG. 17, when a low gradation is specified, the variation in the brightness of the regions A and C in the present embodiment is smaller than the variation in the comparative example.

### C: Specific Configuration of Scanning Line Driving Circuit 32

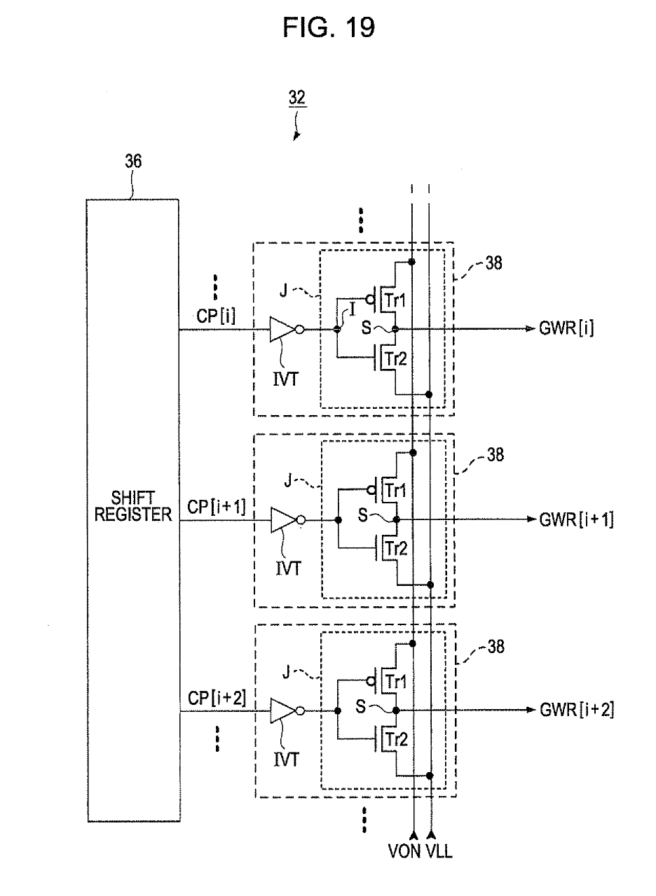

FIG. 19 is a block diagram showing the outline configuration of the scanning line driving circuit 32. As shown in FIG. 19, the scanning line driving circuit 32 includes a shift register 36 and an m output buffers 38 that correspond to the m scanning lines 12 (the m rows in which the pixel circuits U are arranged). The shift register 36 sequentially generates m control signals CP[1] to CP[m] (whose levels are sequentially changed to active levels (high levels) for the unit time periods H (H[1] to H[m]) that are included in the vertical scanning time period) and outputs the control signals CP[1] to CP[m] to the output buffers 38 by sequentially transferring start pulse signals on the basis of clock signals. For example, the high-level control signal CP[i] is output to the i-th output buffer 38 (that is arranged at an i-th stage) for the i-th unit time period H[i] (writing period PWRT).

Each of the output buffers 38 includes an inverter IVT and a unit circuit J. Each unit circuit J is an inverter circuit and includes a P-channel transistor Tr1 and an N-channel transistor Tr2. Each unit circuit J also includes an output terminal S that is connected to the scanning line 12 that corresponds to the unit circuit J. The output terminal S of the i-th unit circuit J is connected to the scanning line 12 that is arranged in the i-th row. A potential of the output terminal S of the i-th unit circuit J is equal to the potential of the scanning signal GWR[i] that is to be output to the scanning line 12 arranged in the i-th row.

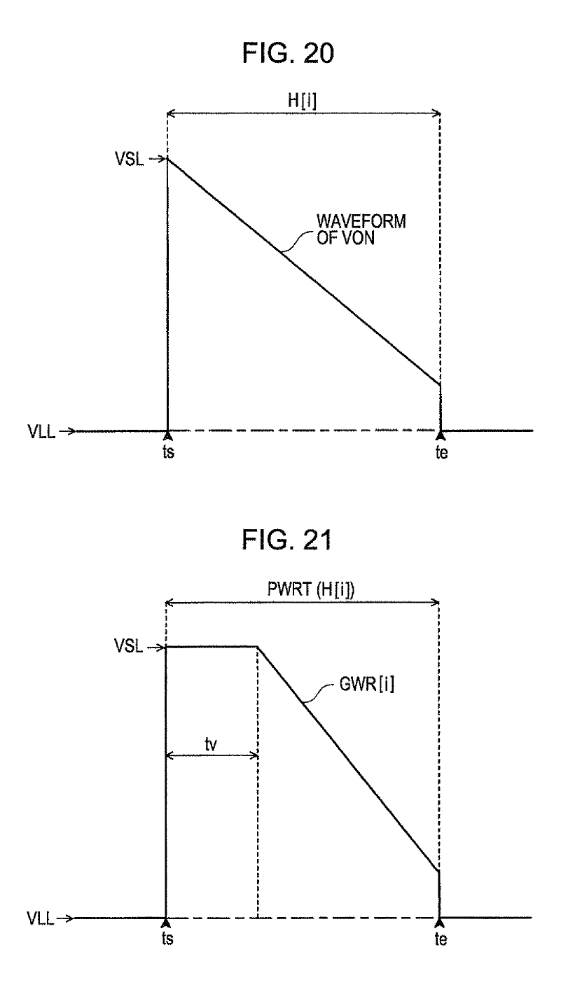

The following describes the case in which the i-th unit circuit J generates the scanning signal GWR[i]. When the i-th unit time period H[i] starts, the high-level control signal CP[i] is supplied to the i-th output buffer 38. The control signal CP[i] is inverted by the inverter IVT so that the level of the control signal CP[i] is changed to a low level. The inverted control signal CP[i] is then supplied to an input terminal T to turn on the transistor Tr1 and turn off the transistor Tr2. Thus, the potential (potential of the scanning signal GWR[i]) of the output terminal S of the unit circuit J is set to a high voltage VON. As shown in FIG. 20, the high potential VON is linearly reduced from the selection potential VSL for the unit time period H[i] (from the start time te to the end time te). The waveform of the high potential VON may be formed by means of a capacitor and a constant electric current. In addition, the waveform of the high potential VON may be formed by a CR circuit that includes a capacitor and a resistor.

The control signal CP[i] that is to be supplied to the i-th output buffer 38 is changed to the low level at the end time te of the unit time period H[i]. The control signal CP[i] is then inverted by the IVT so that the level of the control signal CP[i] is changed to the high level. Then, the inverted control signal CP[i] is supplied to the input terminal I to turn on the transistor Tr2 and turn off the transistor Tr1. The potential (potential of the scanning signal GWR[i]) of the output terminal S is set to the low potential VLL. The potential of the output terminal S is maintained at the low potential VLL until the control signal CP[i] is changed to the high level. In this manner, the waveform of the scanning signal GWR[i] that is output to the scanning line 12 arranged in the i-th row is formed (refer to FIG. 20). The waveforms of the scanning signals GW that are output to the other scanning lines 12 are formed in the same manner.

### D: Modified Examples

The invention is not limited to the aforementioned embodiment and can be applied to the following modified examples. Two or more of the following modified examples may be combined.

### First Modified Example

In the aforementioned embodiment, each of the data signals (data potentials VX) has the so-called ramp waveform, and the potential of each data signal is monotonically increased. When the specified gradation is high, the gradient of the potential of the data signal is steep. When the specified gradation is low, the gradient of the potential of the data signal is gentle. The selecting transistor TS is turned off during the time period when the potential of the data signal is monotonically increased. When a gradation for which the potential of the data signal is constant is specified, or when a gradation (low gradation) for which a change in the potential of the selected signal (scanning signal SWR) is approximately constant is specified, the selecting transistor TS does not need to be turned off during the period time when the potential of the data signal is monotonically increased.

### Second Modified Example

In the aforementioned embodiment, the potential of the scanning signal GWR[i] is set to the selection potential VSL at the start time is of the i-th writing period PWRT ((unit time period H[i]) that is included in the vertical scanning time period) and is linearly reduced over time at a constant rate for the i-th writing period PWRT (from the start time ts to the end time te). The change in the potential of the scanning signal GWR[i] is not limited to the aforementioned embodiment and may be arbitrary. In short, the potential of the scanning signal GWR[i] may be arbitrarily changed as long as the potential of the scanning signal GWR[i] changes over time for the writing period PWRT from the start time ts (when the potential of the scanning signal GWR[i] is set to the selection potential VSL) to the end time te.

In FIG. 11, when the maximum gradation Dmax is specified, the potential of the scanning signal may be arbitrarily set as long as the selecting transistor TS is in the ON state immediately before the selecting transistor TS is switched to the OFF state by an interaction with the data signal. As shown in FIG. 21, the potential of the scanning signal GWR[i] may be maintained at the selection potential VSL for a predetermined time period from the start time ts of the writing period PWRT (unit time period H[i]) to a time tv and be linearly reduced over time at a constant rate after the time tv. In this case, an excessive voltage is not applied to the selecting transistor TS. Thus, it is possible to suppress degradation in the selecting transistor TS due to a voltage applied to the selecting transistor TS and reduce power that is to be consumed by the device.

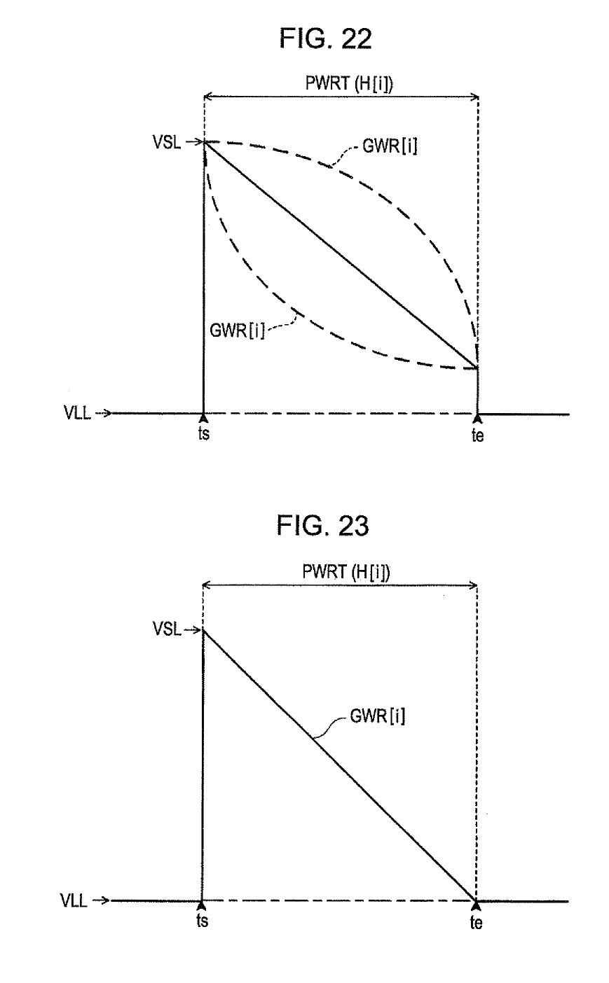

As shown by broken lines in FIG. 22, the potential of the scanning signal GWR[i] may be set to the selection potential VSL at the start time ts of the writing period PWRT (unit time period H[i]) and be reduced along any of the curved lines (broken lines) for the writing period PWRT (unit time period H[i]) from the start time ts to the end time te. In the aforementioned embodiment, the potential of the scanning signal GWR[i] is linearly changed for the writing period PWRT from the start time ts to the end time te to turn off the selecting transistor TS. Thus, the amount of the change in the potential of the scanning signal GWR[i] when the selecting transistor TS is switched to the OFF state is the same regardless of the specified gradation. Therefore, it is possible to suppress a variation (depending on the specified gradation) in the amount of the change (reduction) (that is caused by the feed-through effect that occurs when the selecting transistor TS is changed to the OFF state) in the potential VG of the gate of the driving transistor TDR.

As shown in FIG. 23, the waveform (rate of change of the potential of the scanning signal GWR[i]) of the scanning signal GWR[i] may be set so that the potential of the scanning signal GWR[i] is changed over time for the writing period PWRT and reaches the potential VLL (non-active level) at the end time to of the writing period PWRT.

### Third Modified Example

In the aforementioned embodiment, the timing of when the selecting transistor TS is turned off during the writing period PWRT varies depending on the specified gradation. That is, the timing of when the selecting transistor TS is turned off in the case where a certain gradation is specified is different from the timing of when the selecting transistor TS is turned off in the case where another gradation is specified. However, the selecting transistor TS may be turned off at the same time in the case where a gradation for which the data signal (data potential VX) is constant is specified. In addition, the selecting transistor TS may be turned off at the same time in the case where a gradation (low gradation) for which the potential of the selection signal (scanning signal) GWR is approximately constant is specified.

### Fourth Modified Example

The conductivity type of each of the transistors (driving transistors TDR, selecting transistors TS, light emission control transistors TGEL, first switching elements SW1 and second switching elements SW2) is arbitrary. For example, the driving transistors TDR may be P-channel transistors. When the P-channel driving transistors TDR are used, the levels (high or low levels) of the voltages are reversed compared with the case in which the N-channel driving transistors TDR are used. However, operations of each P-channel driving transistor TDR are essentially the same as the operations of each N-channel driving transistor TDR described in the aforementioned embodiment and are not described in detail.

### Fifth Embodiment

In the aforementioned embodiment, the amount of the driving current IDR that is to be supplied to the light emitting element E is determined on the basis of the rate RX of change of the data potential VX over time at the end time te of the writing period PWRT. Thus, the rate RX of change of the data potential VX over time at the end time te (when the supply of the data potential VX to the gate of the driving transistor TDR is stopped) of the writing period PWRT is preferably set on the basis of the specified gradation. However, the waveform (rate RX of change of the data potential VX over time) of the data potential VX, which is formed for the writing period PWRT, is arbitrary. In order to cause the rate RS of change of the potential VS of the source of the driving transistor TDR over time and the rate RX of change of the data potential VX over time to exactly match each other at the end time te of the writing period PWRT, it is preferable that the rate RX of change of the data potential VX over time be continuously fixed to a value that corresponds to the specified gradation for the predetermined time period (that lasts until the end time te).

### Sixth Modified Example

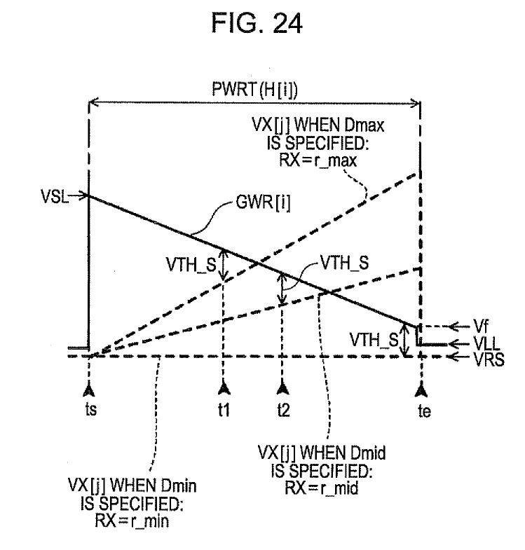

In the aforementioned embodiment, the potential VLL (non-active level) of the scanning signal GWR[i] is set lower than the reference potential VRS for the data potential VX[j] as shown in FIG. 11. The relationship between the potential VLL and the reference potential VRS may be arbitrary. For example, the potential VLL may be set higher than the reference potential VRS as shown in FIG. 24. In this case, when the minimum gradation Dmin is specified, the scanning signal GWR[i] and the data potential VX[j] may be set so that the scanning signal GWR[i] does not cross the data potential VX[j] in a diagram that shows the relationship between the potentials and time.

### Seventh Modified Example

The light emitting elements E may be organic light emitting diode (OLED) elements. In addition, the light emitting elements E may be inorganic light emitting diodes or light emitting diodes. All elements that emit light on the basis of supply (application of electric fields or supply of electric currents) of electric energy may be used as the light emitting elements used in the invention.

### E: Applications

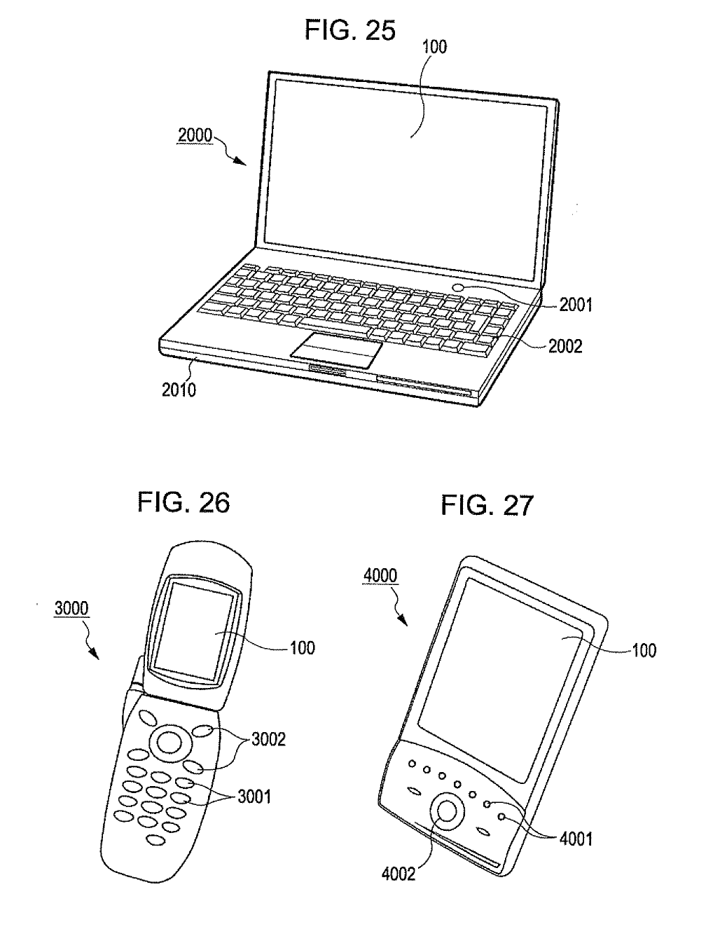

Next, an electronic device that uses the light emitting device according to the invention is described below. FIG. 25 is a perspective view of the configuration of a mobile personal computer that includes, as a display device, the light emitting device 100 according to the aforementioned embodiment. The personal computer 2000 includes the light emitting device 100 (that is used as the display device) and a body portion 2010. The body portion 2010 includes a power switch 2001 and a keyboard 2002. The light emitting device 100 includes OLED elements as the light emitting elements E. Thus, the light emitting device 100 has a wide viewing angle and is capable of displaying a screen that can be easily viewed.

FIG. 26 is a diagram showing the configuration of a mobile phone that includes, as a display device, the light emitting device 100 according to the aforementioned embodiment. The mobile phone 3000 includes a plurality of operating buttons 3001, a plurality of scroll buttons 3002 and the light emitting device 100. A screen that is displayed by the light emitting device 100 is scrolled by operating the scroll buttons.

FIG. 27 is a diagram showing the configuration of a personal digital assistant (PDA) that includes, as a display device, the light emitting device 100 according to the aforementioned embodiment. The personal digital assistant 4000 includes a plurality of operating buttons 4001, a power switch 4002 and the light emitting device 100. When the power switch 4002 is operated, various information such as an address list and an appointment list is displayed by the light emitting device 10.

The electronic device to which the light emitting device according to the invention is applied can be applied to a digital still camera, a television, a video camera, a car navigation system, a pager, an electronic notebook, an electronic paper, a calculator, a word processor, a workstation, a video phone, a point-of-sale (POS) terminal, a printer, a scanner, a copying machine, a video player, a device that has a touch panel, and the like, in addition to the devices shown in FIGS. 25 to 27. The light emitting device 100 according to the invention may be used for purposes other than displaying of an image. For example, the light emitting device 100 according to the invention may be used as an exposure device that exposes the surface of a photosensitive drum with light to form a latent image on the surface of the photosensitive drum in an electrophotographic image forming device.

1. A light emitting device comprising:
a pixel circuit; and
a driving circuit that drives the pixel circuit, wherein
the pixel circuit includes:
a light emitting element;
a driving transistor that is connected to the light emitting element in series;
a storage capacitor that is located between a gate of the driving transistor and a source of the driving transistor; and
a selecting transistor that is located between the gate of the driving transistor and a signal line that corresponds to the pixel circuit,
after a writing period starts, the driving circuit sets a potential of a selection signal to a selection potential to turn on the selecting transistor and outputs a data potential to the signal line to cause a current corresponding to the data potential to flow in the driving transistor, the selection signal being to be supplied to the gate of the selecting transistor, the data potential being changed over time, and
after the driving circuit sets the potential of the selection signal to the selection potential and outputs the data potential, the driving circuit changes, from the selection potential, the potential of the selection signal over time until the end time of the writing period to turn off the selecting transistor and thereby stop supply of the data potential and sets, to a rate corresponding to a gradation specified for the pixel circuit, a rate of change of the data potential at the time when the supply of the data potential to the driving transistor is stopped.

2. The light emitting device according to claim 1, wherein
the potential of the selection signal is changed over time at a constant rate after the potential of the selection signal is set to the selection potential and until the end time of the writing period.

3. The light emitting device according to claim 1, wherein
the potential of the selection signal is set so that the selecting transistor is turned off during the writing period after the rate of change of the potential of the gate of the driving transistor over time becomes equal to the rate of change of the potential of the source of the driving transistor over time.

4. The light emitting device according to claim 1, wherein
the pixel circuit further includes:
a first switching element that is located between the source of the driving transistor and a reset line;
a second switching element that is located between an initialization line and a node that is located between the gate of the driving transistor and the selecting transistor; and
a light emission control transistor that is connected to the light emitting element and the driving transistor in series,
the driving circuit turns off the light emission control transistor and the selecting transistor and turns on the first switching element and the second switching element for an initialization period that ends before the writing period so that a voltage that is applied across the gate and source of the driving transistor is initialized,
the driving circuit performs a compensating operation to turn off the first switching element and turn on the light emission control transistor for a compensation period that starts after the initialization period and ends before the writing period so that the voltage that is applied across the gate and source of the driving transistor becomes asymptotic to a threshold voltage, and
the driving circuit turns off the second switching element for the writing period and keeps the light emission control transistor turned on for a light emission period to change the potential of the source of the driving transistor so that the light emitting element emits light, the light emission period starting after the writing period.

5. The light emitting device according to claim 4, wherein
the potential of the source of the driving transistor is set so that the light emitting element is in a non-emission state for the initialization period, the compensation period and the writing period.

6. The light emitting device according to claim 1, wherein
a voltage that is applied across both ends of the storage capacitor is set so that a current flows in the driving transistor, the amount of the current corresponding to a value obtained by multiplying a capacitance of a capacitor by the rate of change of the data potential over time at the time when the supply of the data potential to the driving transistor is stopped, the capacitor being provided for the light emitting element.

7. An electronic device comprising the light emitting claim 1.

8. A method for driving a pixel circuit that includes a light emitting element; a driving transistor that is connected to the light emitting element in series; a storage capacitor that is located between a gate of the driving transistor and a source of the driving transistor; and a selecting transistor that is located between the gate of the driving transistor and a signal line that corresponds to the pixel circuit, comprising:
after a writing period starts, setting a potential of a selection signal to a selection potential to turn on the selecting transistor and outputting a data potential to the signal line to cause a current corresponding to the data potential to flow in the driving transistor, the selection signal being to be supplied to the gate of the driving transistor, the data potential being changed over time at a rate that corresponds to a gradation specified for the pixel circuit; and
after the setting of the potential of the selection signal to the selection potential and the outputting of the data potential, changing the potential of the selection signal over time from the selection potential until the end time of the writing period to turn off the selecting transistor and thereby stop supply of the data potential to the driving transistor, and setting, to a rate that corresponds to the gradation specified for the pixel circuit, a rate of change of the data potential at the time when the supply of the data potential to the driving transistor is stopped.

9. An electronic device comprising the light emitting device according to claim 2.

10. An electronic device comprising the light emitting device according to claim 3.

11. An electronic device comprising the light emitting device according to claim 4.

12. An electronic device comprising the light emitting device according to claim 5.

13. An electronic device comprising the light emitting device according to claim 6.
